(19) United States
(12) Patent Application Publication
(10) Pub. No.: US 2011/0284392 A1
(43) Pub. Date: Nov. 24, 2011

(54) Electrochemical Reactor

(75) Inventors: Sandro Quadrelli, Zola Predosa (BO) (IT); Sergio Ferro, Ferrara (IT)

(73) Assignee: GIMA S.P.A., Zola Predosa (BO) (IT)

(21) Appl. No.: 13/129,277

(22) PCT Filed: Nov. 12, 2009
(86) PCT No.: PCT/EP2009/065077

§ 371 Date: Aug. 5, 2011

(30) Foreign Application Priority Data
Nov. 13, 2008 (IT) BO2008A 000688

(51) Int. Cl. C02F 1/461; C25B 9/18; C25B 9/00

(52) U.S. Cl. 205/746; 204/263; 204/257; 204/266

(57) ABSTRACT

An electrochemical reactor comprises at least one electrolytic cell, each cell is divided by a membrane (12) into two electrode chambers (7, 8), each one is crossed by flows of liquid and each having at least a corresponding electrode (13, 14). Both the electrodes (13, 14) have one own face directly in contact with the membrane (12) and have a plurality of openings (21) for the passage of the liquid. Each electrode (13, 14) is provided with one or more contact means (15) for the power supply.

### TECHNICAL FIELD

The present invention concerns an electrochemical reactor for the electrochemical activation of water and, in particular, for the electrolytic treatment of aqueous solutions containing halides, for producing neutral solutions (or with a nearly neutral pH, i.e. between 6.0 and 7.5) to be used as disinfectants and/or sterilizing agents.

### BACKGROUND OF THE INVENTION

The electrolytic treatment of weakly saline waters (otherwise known as “diluted brines”, because the dissolved salts are a few grams per liter) is a process described in the literature with the term “electrochemical activation of water”. In order to carry out the electrochemical process, the reactor size must be appropriately chosen; in particular, in consideration of the high resistivity of diluted electrolyte solutions, the inter-electrode distance has to be maintained at properly low values, so as to limit the ohmic drop and thus the potential difference applied to the electrodes.

As an example, one can consider the Russian-designed tubular cells described in EP 0842122 B1 (Bakhir and Zadorozhny): they have a very small inter-electrode distance (about 3 mm) and are equipped with a ceramic separator, which is quite fragile and delicate (its wall thickness is less than 1 mm), representing also a constraint for the reactor size (and hence for its productivity). Flowing through the aqueous solution, current lines are perpendicular to both the electrode surfaces and the diaphragm; in addition, given the cylindrical geometry of the system, the current lines have also a radial distribution. Other examples of cells for the electrochemical activation of water should be considered structural variations of the previous one; possible examples are those reported in EP 0922788 B1 (Naida and Pushnyakov), or in GB 2449735 A (Iltsenko and Naida): in both cases, the reactor maintains the above cylindrical geometry, as well as the ceramic diaphragm to separate the electrode compartments.

Moving to the field of chlor-alkali industrial cells, electrode structures in direct contact with the separator (either a diaphragm or a membrane), the latter being placed between the two electrode compartments, are known. As an example, a membrane-type electrolytic cell is described in WO 85102419 (Johnson): two porous electrodes (permeable to both the electrolyte solution and the gas produced by the electrolytic process) are pressed against the membrane to form a so-called “zero-gap structure”, i.e. an intimate contact between adjacent components, which can anyway be disassembled at request. In chlor-alkali synthesis, cells of this type are usually fed with brines close to saturation concentrations (250-300 g/l NaCl ).

As discussed, for example, in U.S. Pat. No. 7,141,147 B2 (Shimamune) and in EP 1577424 A1 (Houda and Noaki), a proper zero-gap configuration requires also the presence of suitably flexible means, aimed at maintaining a predetermined pressure between the electrode elements and the membrane interposed between them; generally, said elastic element represents a portion of the cathode device itself, which is thus made up of several layers.

A quite advanced electrochemical reactor, for the treatment of diluted brines, is described in EP 1969159 B1 (Bohnstedt et al.): it comprises two cells equipped with planar electrodes in separated compartments, the presence of a separator preventing that what produced at the anodes could be reduced at the cathodes (with obvious decreases for the yield of the electrochemical synthesis).

The reactor design allows the diluted brine to be initially subjected to the cathodic treatment and subsequently to the anodic one, with the result that the outgoing solution contains oxidizing (“active”) chemical species and has a pH close to neutrality (usually in the range between 6.5 and 7.5).

Despite the engineering solution described in EP 1969159 B1 represents a significant improvement, compared to what was previously proposed by technology, there remain some issues, particularly detectable in the following points:

the thin membrane that separates each anode chamber from the cathode one requires the use of appropriate spacers, which support the membrane while maintaining a distance from the latter and the electrode surfaces; since these spacers are immersed in the electrolyte solutions, experiencing their chemical aggression, they are progressively deteriorated and require to be regularly substituted;
even though the distance between electrodes (anode and cathode, in their respective chambers) is relatively low, the resistivity of diluted electrolyte solutions is anyway responsible for significant ohmic drops, which result in energy costs and in the need to adopt appropriately oversized current generators;
since the heat produced by Joule effect is proportional to the resistivity of the medium interposed between the electrode surfaces, the problem described in the preceding paragraph shall also determine significant heating effects for both the solution and the electrodes, with possible consequences on the process yield as well as on the service life of the different components of the device.

### DISCLOSURE OF THE INVENTION

An object of the present invention is to overcome the limitations described above and in the known technique, making available a reactor comprising electrolytic cells, suitable for the electrochemical activation of diluted brines, with no spacers between the membranes and the electrode surfaces.

A second object of the present invention is to provide an engineering solution that minimizes the Joule effect due to current flow, resulting in an improved process yield and reduced risks of unwanted side reactions (such as the synthesis of chlorites, chlorates or perchlorates, as a result of the treatment of chloride-containing solutions).

Under a further aspect, it is an object of the present invention to make available an electrochemical reactor capable of producing electrochemically activated solutions having a pH close to neutrality, being powered with potential differences significantly lower than those required by the state of the art.

The present invention relates to a reactor comprising three inner rooms, consisting of an expansion chamber and two electrolytic cells, obtained within a single structure; outwardly, this structure looks like a box-shaped parallelepiped, formed by two halves that are assembled to form a coherent whole. Within said structure, the liquid flow is adjusted so that there is an initial, single passage within the cathode chambers (the incoming liquid is distributed between them), and a subsequent anodic treatment in the two anode rooms, which are passed through in sequence. Leaving the cathode chambers, and prior to the anodic processes, the liquid flows through the intermediate expansion chamber, in which a separation between the liquid and the gas produced during the cathodic process takes place.

As briefly described in the examination of the state of the art, the electrolytic reactors for the synthesis of electrochemically activated water are usually characterized by an inter-electrode distance of a few millimeters as well as by the presence of a ceramic diaphragm arranged between these electrodes, at an appropriate distance from them. The authors of the present invention have found a way to obtain similar results even with significantly lower inter-electrode distances, and with the use of cation-exchange polymeric membranes (replacing the ceramic diaphragm), provided that the chosen electrodes and membrane have appropriate characteristics.

Through a series of tests, the authors of the present invention have verified the feasibility of using zero-gap structures within a reactor for the electrochemical activation of water, and how it allows an efficient synthesis of electrochemically activated solutions, while solving a number of drawbacks.

It would be reasonable to assume that the use of a zero-gap structure within an electrochemical cell for the electrochemical activation of water were counterproductive: actually, the inter-electrode distance must be kept at values not too high but, conversely, an over-minimization of that distance may lead to a corresponding reduction in cell potential, with consequent negative effects on the electrochemical activation process. Therefore, it has to be regarded as unexpected the result reached by the authors of the present invention, who identified the way to overcome the prejudices of the state of the art.

### BRIEF DESCRIPTION OF THE DRAWINGS

The description of the present invention will be more understandable while referring to the attached drawings:

FIG. 1 illustrates an isometric view of the electrochemical reactor, object of this invention, in which also a power generator is drawn;

FIG. 2 is an exploded view of the reactor illustrated in FIG. 1, showing details of the two halves of the reactor; in this figure, electrodes are represented in a purely schematic form;

FIGS. 3 and 4 are views of the inner faces of the two halves of the reactor;

FIGS. 5 and 6 are sectional views according to plan traces A-A′ and B-B′ shown in FIG. 3;

FIG. 7 illustrates a partial and enlarged view of a detail of FIG. 6;

FIG. 8 shows an enlarged, detailed isometric view of any of the electrodes of FIG. 2, used for carrying out the present invention.

### BEST MODE OF CARRYING OUT THE INVENTION

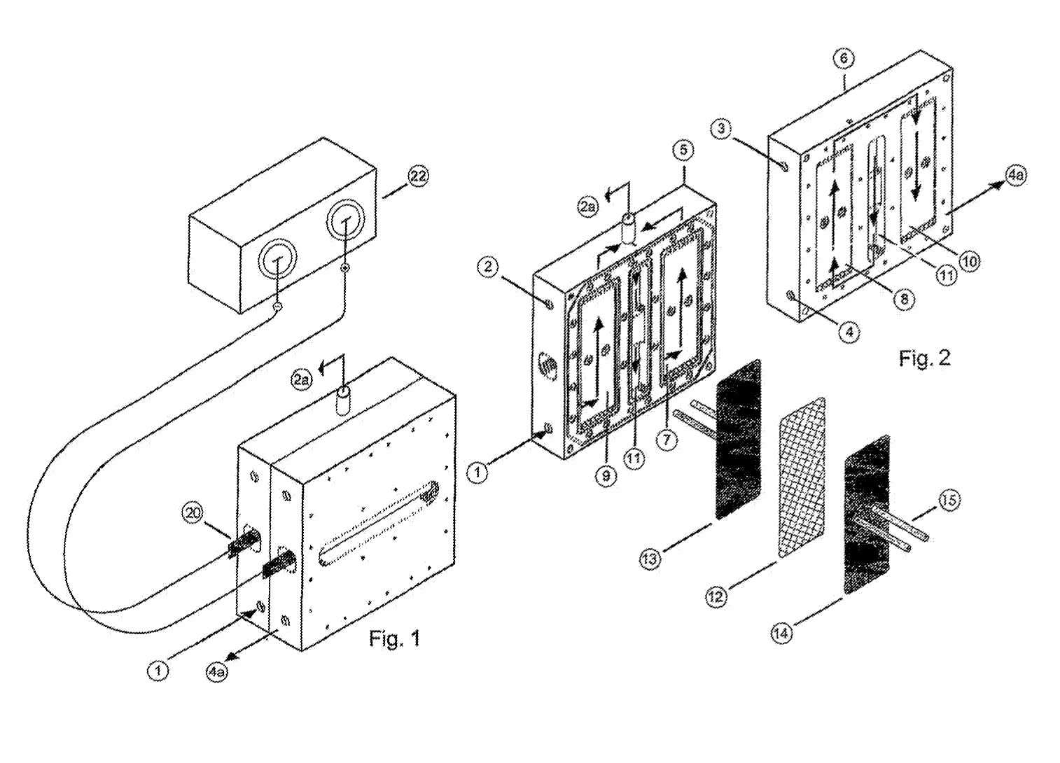

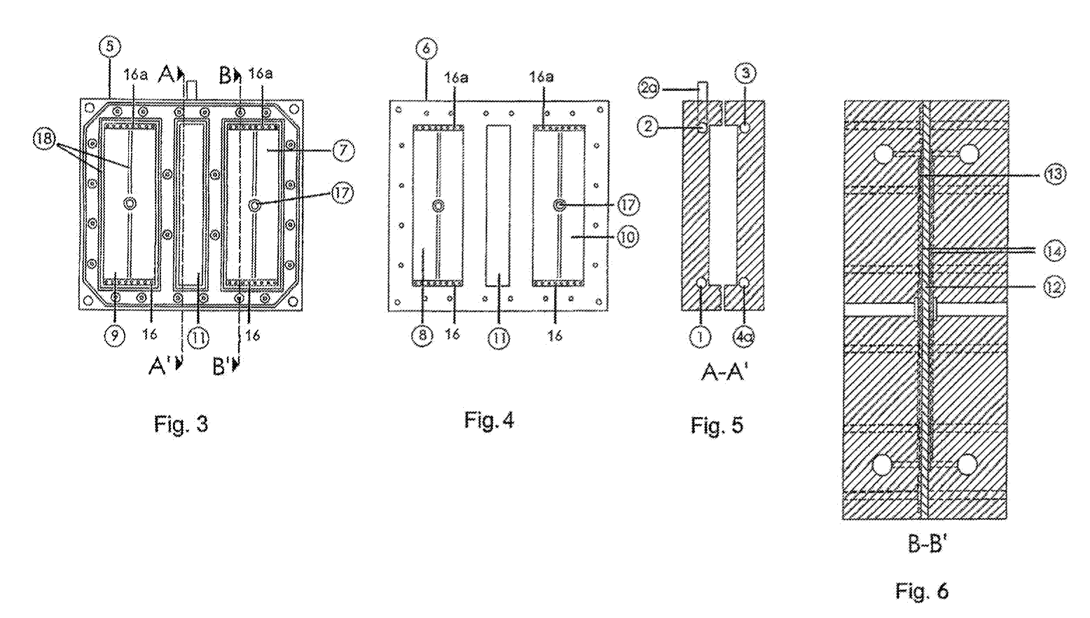

The electrochemical reactor object of the present invention is shown in assembled form in FIG. 1. That reactor is equipped with three internal cavities, produced in the bodies 5 and 6 of the reactor, as shown in FIG. 2; each lateral cavity represents an electrochemical cell, which is divided by a membrane 12 in two faced chambers 7-8, 9, 10, each crossed by liquid flows and each equipped with at least one respective electrode 13 (at the cathode side, in the body 5 of the reactor) and 14 (at the anode side, in the body 6 of the reactor) having a flat face directly in contact with the membrane 12. Each electrode 13, 14 has a plurality of openings 21 that allow the passage of the liquid: these openings 21 consist of holes through the thickness of that electrode 13, 14; preferably, the openings 21 are regularly distributed, as a matrix, over the entire surface of the electrode 13, 14. More specifically, each electrode 13, 14 can be obtained from a network or a stretched and flattened metal sheet; the openings 21 may have different forms: in general, they are diamond-shaped with axes size between 0.3 and 5 mm, and more preferably between 1 and 3 mm. The electrode main surfaces are flat and mutually parallel, and the face in contact with the membrane is preferably free of protrusions or bumps that might damage the membrane itself.

The electrodes 13, 14 are made of an electrically conducting material, metal, metal alloy or glassy carbon; it is preferable to use either titanium (pure or containing any impurity) or a metal alloy in which titanium is the major component; other valve metals can be considered (such as tantalum, zirconium or niobium), as well as nickel, copper or stainless steel. The electrically conductive substrate can then be coated with a suitable catalyst, and this applies in particular for the electrode that will be housed in the anode compartment of each electrochemical cell. Suitable catalysts are those noble metals of the platinum family (Ir, Ru, Os, Rh, Pd, Pt), their oxides, either pure or blended with other oxides, and particularly with valve metal oxides as well as oxides of titanium and tin.

Each electrode 13, 14 has a thickness of between 0.01 and 4 mm, and preferably between 1 and 2 mm; it is also provided with one or more contact means 15 for the electric connection to a power supply.

Each electrode 13, 14 is then shaped as a net or a perforated plate, and has one own flat face directly in contact with a membrane 12; the latter divides the internal cavity into two electrode chambers 7, 8; 9, 10, in which the electrodes 13, 14 are housed: the liquid to be electrochemically treated flows in rooms 7, 8, 9 and 10 and laps the face of the electrode 13, 14 opposite to that in direct contact with the membrane 12, arriving also to wet the membrane itself, through the openings 21 present on the electrode 13, 14.

Each electrode chamber 7, 8, 9, 10 is provided with lateral seats 18 to accommodate lateral side edge portions of the respective electrode 13, 14; these seats 18 of the chamber 7, 8, 9, 10 laterally delimit the passage 19, which has a shape in plan similar to that of the electrode. The passage 19 permits the flow of the liquid entering and leaving the chamber 7, 8, 9, 10 through inflow 16 and outflow ducts 16a present in the chamber itself the width of the passage is sufficient for the liquid to pass with little resistance and is somewhat lower than the other dimensions of the passage itself. In particular, the chamber 7, 8, 9, 10 has the appearance of a flattened parallelepiped, with a depth between 0.2 and 9 mm and preferably between 1 and 5 mm; the width of the passage 19 is between 0.1 and 5 mm, and preferably between 0.5 and 3 mm.

From the above description, it follows that the depth of each electrode chamber 7, 8, 9, 10, corresponding to the combined thickness of the electrode with the width of the passage for the liquid, is between 0.2 and 9 mm, where the electrode thickness 13, 14 is between 0.1 and 4 mm, and the thickness of the passage for the liquid 19 is between 0.1 and 5 mm. The depth of each electrode chamber 7, 8, 9, 10 is preferably between 1 and 5 mm, and the ratio between the width of the passage for the liquid 19 and the thickness of the electrode 13, 14 is preferably between 0.5 and 2.

Finally, each chamber 7, 8, 9, 10 contains one or more supporting means 18 intended for touching the electrode 13, 14 while supporting it.

The membrane 12 is shaped in form of sheet or film, usually in polymeric organic material, possibly halogenated, or composite (organic/inorganic), and is provided with active groups such as carboxyl, sulfonic or amine groups; said polymeric membranes can have a single layer or multiple layers, and may contain reinforcing plastic gratings, often Teflon™-based. Among the different polymeric membranes that can be used, examples are those produced by DuPont (known as Nafion™), Asahi Glass (Flemion™) and Fumatech (Fumapem™ and Fumasep™). The edge of that membrane is tightly sealed between the two bodies 5 and 6 of the reactor.

Each of the above-mentioned supporting means 18 consists in a branch or rib, for example straight, obtained in the respective body 5 or 6, protruding in the chamber and longitudinally crossing all or part of the passage 19, touching the electrode 13, 14 in its face opposite to the membrane 12, so that he could not leave or bend over from its correct position of total contact with the membrane 12.

The membrane 12 is tightened between two flat, facing and opposing electrodes 13 and 14, each one in direct contact with a respective side of said membrane 12, and the membrane portion tightened between the electrodes is coplanar with the membrane edge tightened between the two bodies 5 and 6 of the reactor: in this way, the membrane is not subjected to any particular stress, is well protected and almost insensitive to vibration or shock, as well as to any difference in pressure that could create in the electrode chambers during the reactor functioning.

The inlet and outlet ducts for fluids 1, 2, 3, 4 and 4a, as well as that for venting the produced gases 2a, are obtained, at least in part, in the bodies 5 and 6 of the reactor.

Each contact means 15 is orthogonal to the plane of the respective electrode 13, 14 faces and exits the chamber 7, 8, 9, 10 through a hole 17 obtained in a body 5 or 6 of the reactor, to allow electrical connection to a connection means 20, having for example the form of a bar or rod with holes for coupling with the electrical contacts. Said connection means 20 may be sliding pushed in a respective location, obtained in the reactor body 5 or 6, where the holes 17 for the passage of the contact means 15 are located.

Each contact means 15 also includes a threaded portion that can be mated with threaded nut means for connecting to the connection means 20; the latter is thus provided with connections for different contact means 15, for at least two electrodes, as well as for the electrical wiring connection to the polarity of an electric source 22.

The portion of the seat for the electrical connection means 20 opposite to the holes 17 for the contact means 15 is open to the outside through a buttonhole, to allow the screwing of the threaded nuts to the threaded portions of the contact means 15. The contact of the electrical connection means 20 for connecting the electrical wires is preferably obtained on one end of the same electrical connection means 20, which protrudes from the body of the reactor.

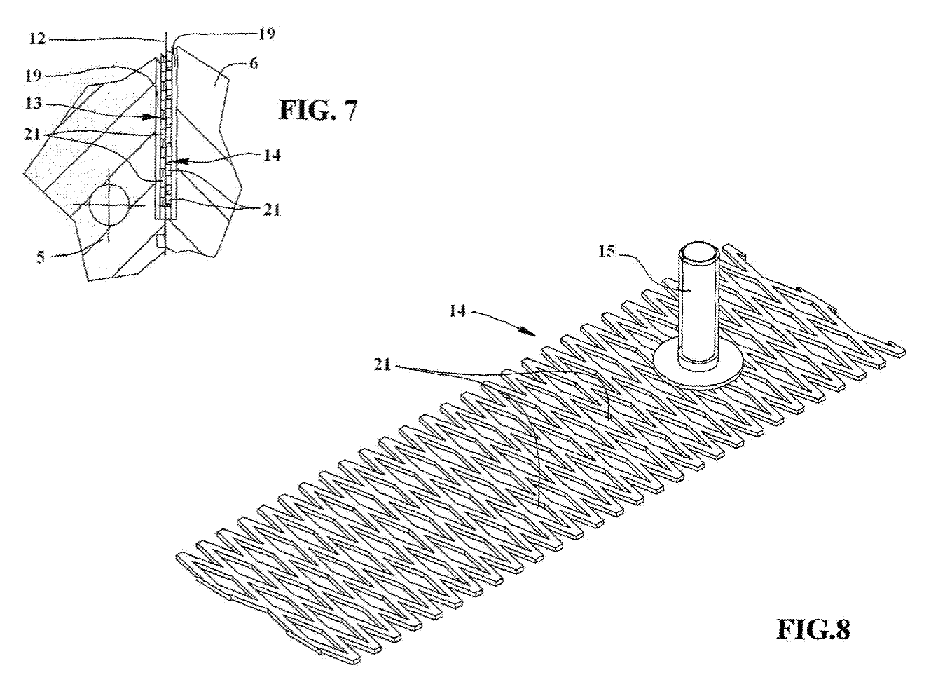

The innovative aspects of the present invention will be made more evident considering the conditions of use of the reactor, while referring in particular to FIGS. 2 and 7.

As discussed by Vitold Bakhir for example in “Theoretical aspects of the electrochemical activation” (Summaries of papers and brief reports -Second International Symposium on Electrochemical Activation in Medicine, Agriculture and Industry, Moscow 1999), the effects of electrochemical activation of water are more marked and persistent, the lower the degree of mineralization of the treated water. Considering the relaxation phenomena that restore the water conditions as they were before the electrochemical activation, the most significant changes occur when the treated water has a mineral content between 0.1 and 1 g/l. The magnitude of these changes decreases if the degree of mineralization is either reduced from 0.1 g/l to zero, or increased from 1 to 5 g/l; for a mineralization content exceeding 5 g/l, changes related to the relaxation phenomena become progressively less evident, disappearing at all if the mineral content increases to approximately 100 g/l. Thus, in order to maximize the effects of the electrochemical activation while minimizing the energy expenditure required for the attainment of such activation, it is convenient to consider solutions containing a few grams per liter of dissolved salts, preferably less than 10 g/l and more preferably around 5 g/l.

Drinking water typically, and mostly, contains chloride ions and sodium ions; other chemical species may be sulfates, carbonates, calcium and magnesium ions; to a minor extent, also iron and nitrate ions can be found, as well as dissolved gases including oxygen and nitrogen. In order to prepare an electrochemically activated solution, to be used as a disinfectant or sterilizing agent, it is particularly advisable to use softened or demineralized water, to which an alkali metal halide, such as sodium chloride or chloride potassium, is added in amounts from 1 to 10 g/l, and preferably in amounts between 3 and 6 g/l. In what follows, said solution will be referred to as diluted brine.

The diluted brine entering the reactor first passes through the cathode compartments 7 and 9, by distributing itself between the two chambers by means of the apposite conduct 1 obtained within the body 5 of the reactor; subsequently, the solution reaches the anode compartments 8 and 10, which are crossed in sequence (the liquid distribution that takes place at the cathode side is not reproduced at the anode side). With reference to FIGS. 2 and 7, the liquid flows through the passage 19 of a cathode chamber 7, 9 on one side of the membrane 12, lapping the cathode 13 and also wetting the membrane 12 through the openings 21 present on the electrode 13. The fluid leaving the chamber 7, 9 passes across the intermediate expansion chamber (obtained in the body of the reactor by the coupling of the two half-rooms 11, in which the gas produced by the cathodic process are separated from the liquid and discharged, together with a part of the liquid, through the outlet tap 2a placed on the top of the body 5 of the reactor. Through a proper regulation of the outgoing fluid volume, it is possible to adjust the pH of the electrochemically activated solution produced by the reactor itself said pH is preferably between 6.0 and 7.5. Subsequently, the fluid leaves the expansion chamber through the conduit 4 and reaches the first anode chamber 8, in which a first anode 14 is located. The solution flows alongside the anode 14 and, for the presence of the holes 21 present on the electrode, is also able to wet the membrane 12. The dynamics of the processes that take place in rooms 7, 9 and 8 are similar, the only difference being that the two electrodes 13 and 14, in contact with opposite sides of the membrane 12, are polarized in the opposite way, one being the cathode (negative polarity) and the other being the anode (positive polarity). Finally, the liquid that comes out of the first anode chamber 8 through the drainage holes 16a, passes across the duct 3 and enters the second anodic chamber 10, prior to leave the reactor through the outlet duct 4a.

By focusing on one or the other electrode chambers of the cell portion shown in FIG. 7, it is easy to recognize the membrane 12, the electrode 13, 14 in contact with it 25 through one of its surfaces and that points the other surface toward the passage 19, which is delimited by the electrode surface and the bottom of the chamber (body 5 or 6 of the reactor).

Since the diluted brine penetrates with difficulty between the electrode and the membrane, the electrode surface directly in contact with the membrane is unable to operate well: as a result, the electrochemical reaction takes place preferentially on the electrode surface pointed toward the passage 19, where the liquid flows, and the current lines between that face and the corresponding electrode face on the other side of the membrane does not take a straight course but circular, penetrating through the holes 21 present on the electrodes 13, 14. In consideration of that, the catalytic layer that coats the electrodes 13, 14 may well cover both the sides of the same (acting as a protective coating against a chemical or electrochemical corrosion of the conductive substrate) but will have to be especially localized on each electrode face opposed to the one in direct contact with the membrane 12. The inter-electrode space is then equal to the sum of the thicknesses of the two electrodes on both sides of the membrane plus the thickness of the membrane itself. As previously mentioned, in order for the cell voltage to remain within acceptable values, the thickness of each electrode 13, 14 should preferably be selected from 1 to 2 mm.

In addition, the authors of the present invention have highlighted that also the membrane plays an important role: in particular, it acts as an ion exchanger (mostly protons and sodium cations, in the case of a diluted sodium halide brine). Without wishing to bind to any particular theory, it is reasonable to assume that the solution at the cathode side is enriched with hydroxyl anions, which are generated due to water reduction: if the membrane is sufficiently thin and permeable to other ionic species (in addition to cations), the hydroxyl anions can cross the membrane, attracted by the electric field, and discharge on the anode, producing oxygen. This is a phenomenon against which precautions should be taken, in order to limit it, since the discharge of hydroxyl anions can depolarize the anode, preventing or limiting the formation of the active species of interest. It is therefore preferable to choose a membrane with a thickness >150 microns, and with proper physico-chemical characteristics; in tests 25 performed in the laboratory, the Nafion™ membrane produced by DuPont showed to be particularly convenient and performing.

The functioning of the reactor object of the present invention will now be presented through some examples; by way of comparison, a first comparative example based on the use of the reactor described in EP 1969159 B1 is reported too.

### EXAMPLE 1

The electrolytic reactor described in EP 1969 159 B 1 (equipped with DSA® electrodes produced by DeNora at the anode side, with Hastelloy 22 stainless steel electrodes at the cathode side and with Fumapem™ membranes by Fumatech, with a 60 microns thickness) was fed with a diluted brine containing about 4.5 g/l NaCl (conductivity of the brine: about 6.5 mS/cm), at a flow rate of 80 l/h. By setting a potential difference of 18 V between the electrical connection means, a current of 85 A was measured. The solution exiting from the reactor had a pH of 7.1, a redox potential equal to +800 mV_{SCE} (measured by a platinum wire against a Saturated Calomel Electrode, as indicated by the initials SCE) and an oxidizing substances content (determined by iodometric titration and expressed as “active chlorine”) equal to 200 mg/l. It was also pointed out that the solution had a temperature of about 36° C., nearly 10 degrees higher than the inflowing solution (which temperature was around 26.5° C.).

### EXAMPLE 2

The reactor object of the present invention (equipped with titanium mesh electrodes—obtained from a stretched and flattened sheet of Ti—covered with a catalytic layer containing IrO₂ and RuO₂ at the anode side, with titanium mesh electrodes covered with a platinum-containing catalytic coating at the cathode side, and Fumapem™ membranes by Fumatech between these electrodes) was fed with a diluted brine containing about 5 g/l NaCl (conductivity of the brine: about 7.5 mS/cm), at a flow rate of 90 l/h. By setting a potential difference of 7.5 V between the electrical connection means, a current of 90 A was measured. The solution exiting from the reactor had a pH of 7.2, a redoxpotential amounting to +865 mV_{SCE} and an oxidizing substances content (determined by iodometric titration and expressed as “active chlorine”) equal to 170 mg/l.

### EXAMPLE 3

The reactor of the example 2 was opened and the Fumapem™ membranes by Fumatech were replaced with Nafion™ membranes produced by DuPont (thickness: about 250 microns); furthermore, the cathodes with the platinum-based catalytic coating were replaced with two titanium mesh electrodes without any catalytic layer. Once the reactor was reassembled, it was fed with a diluted brine containing about 4.5 g/l NaCl (conductivity of the brine: about 6.5 mS/cm), at a flow rate of 90 l/h. By setting a potential difference of 9 V between the electrical connection means, a current of 72 A was measured. The solution exiting from the reactor had a pH of 7.2, a redox potential amounting to +870 mV_{SCE} and an oxidizing substances content (determined by iodometric titration and expressed as “active chlorine”) equal to 230 mg/l.

### EXAMPLE 4

The reactor of the example 3 was fed with a diluted brine containing about 5.5 g/l NaCl (conductivity of the brine: about 8.4 mS/cm), at a flow rate of 110 l/h. By setting a potential difference of 9 V between the electrical connection means, a current of 77 A was measured. The solution exiting from the reactor had a pH of 7.2, a redox potential amounting to +870 mV_{SCE} and an oxidizing substances content (determined by iodometric titration and expressed as “active chlorine”) equal to 265 mg/l.

### EXAMPLE 5

The reactor of the example 3 was fed with a diluted brine containing about 4.5 g/l NaCl (conductivity of the brine: about 6.5 mS/cm), at a flow rate of 130 l/h. By setting a potential difference of 12 V between the electrical connection means, a current of 110 A was measured. The solution exiting from the reactor had a pH of 7.3, a redox potential 25 amounting to +810 mV_{SCE} and an oxidizing substances content (determined by iodometric titration and expressed as “active chlorine”) equal to 220 mg/l. During this test, a slight increase in temperature of the outflowing solution was found (+6 degrees: inflowing solution at 17° C., outflowing solution at 23° C.); using a special probe, the temperatures of the two cathodes were monitored, through their respective current connection means, resulting in about 40 and about 50° C. (the electrode closest to the inflowing solution inlet had the lowest temperature).

### EXAMPLE 6

The reactor of the example 3 was fed with a diluted brine containing about 4.5 g/l NaCl (conductivity of the brine: about 6.5 mS/cm), at a flow rate of 110 l/h. By setting a potential difference of 9 V between the electrical connection means, a current of 48 A was measured. The solution exiting from the reactor had a pH of 7.2, a redox potential amounting to +780 mV_{SCE} and an oxidizing substances content (determined by iodometric titration and expressed as “active chlorine”) equal to 225 mg/l. The temperatures of the two cathodes were monitored, through their respective current connection means, resulted to be 22.4 and 26° C. (the electrode closest to the inflowing solution inlet had the lowest temperature).

1. An electrochemical reactor comprising at least one electrolytic cell, the electrolytic cell being divided by a membrane (12) into two electrode chambers (7, 8), each electrode chamber being crossed by flows of liquid and each electrode chamber having at least one corresponding electrode (13, 14); wherein:
both electrodes (13, 14) have one face directly in contact with the membrane (12) and both electrodes have a plurality of openings (21) for the passage of the liquid therethrough; and
each electrode (13, 14) is provided with one or more contact means (15) for connection to a power supply.

2. The reactor according to claim 1 wherein the reactor further comprises an expansion chamber and has at least two electrolytic cells.

3. The reactor according to claim 1 wherein a depth of each electrode chamber (7, 8, 9, 10), corresponding to a combined thickness of the electrode with a width of a passage (19) for delivering the liquid to the openings (21), is between 0.2 and 9 mm, where a thickness of the electrode (13, 14) is between 0.1 and 4 mm, and a width of the passage for the liquid (19) is between 0.1 and 5 mm.

4. The reactor according to claim 3 wherein the depth of each electrode chamber (7, 8, 9, 10) is between 1 and 5 mm.

5. The reactor according to claim 3 wherein a ratio between the width of the passage (19) for the liquid and the thickness of the electrode (13, 14) is between 0.5 and 2.

6. The reactor according to claim 1 wherein the reactor has two bodies (5 and 6), the membrane (12) being tightened between two flat, facing and opposing electrodes (13, 14), each electrode being in direct contact with a respective side of said membrane (12), the membrane portion tightened between the electrodes being coplanar with a membrane edge tightened between the two bodies (5 and 6) of the reactor.

7. The reactor according to claim 1 further comprising a catalytic layer that covers the electrode (13, 14), the catalytic layer being localized on an electrode face opposed to the electrode face in direct contact with the membrane (12).

8. The reactor according to claim 1 wherein at least one electrode (13, 14) is coated with a catalyst, selected from the group consisting of one or more noble metals of the platinum family (Ir, Ru, Os, Rh, Pd, Pt), their oxides, either pure or blended with other oxides, valve metal oxides and oxides of titanium and tin.

9. The reactor according to claim 1 wherein the membrane (12) is shaped as a sheet or film made of a polymeric organic material.

10. The reactor according to claim 6 wherein the membrane has a single layer or multiple layers, and optionally contains reinforcing plastic gratings.

11. The reactor according to claim 1 wherein each chamber (7, 8, 9, 10) contains one or more supporting means (18) for contacting and supporting the electrode (13, 14).

12. The reactor according to claim 1 wherein each contact means (15) is orthogonal to the plane of the electrode (13, 14) faces and exits the chamber (7, 8,9, 10) through a hole (17) obtained in a body (5 or 6) of the reactor, to allow electrical connection to a connection means (20); each contact means (15) including a threaded portion that can be mated with threaded nut means for connecting to the connection means (20), the connection means being provided with connections for different contact means (15), for at least two electrodes (13, 14), and for completing the electrical wiring connection to an electric source (22).

13. The reactor according to claim 6 further comprising inlet and outlet ducts for fluids (1, 2, 3, 4, 4a), and for venting produced gases (2a), provided in the bodies (5, 6) of the reactor.

14. The reactor according to claim 2 wherein the flows of liquid are adjusted so that there is an initial, single passage within the two cathode chambers (7, 9), the incoming liquid being distributed between them, and a subsequent passage through the two anode chambers (8, 10) for providing an anodic treatment thereof in sequence.

15. The reactor according to claim 1 wherein a pH of an electrochemically activated solution produced by passage through the reactor is between 6.0 and 7.5.

16. A method for electrochemical activation of diluted brines comprising:
providing an electrochemical reactor having at least one electrolytic cell, the electrolytic cell being divided by a membrane (12) into two electrode chambers (7, 8), each electrode chamber being crossed by flows of liquid and each electrode chamber having at least one corresponding electrode (13, 14); wherein both electrodes (13, 14) have one face directly in contact with the membrane (12) and both electrodes have a plurality of openings (21) for the passage of the liquid therethrough, and each electrode (13, 14) is provided with one or more contact means (15) for connection to a power supply; and,
passing a diluted brine containing an alkali metal halide in an amount between 3 and 6 g/l through the reactor.

17. The method for the electrochemical activation of diluted brines according to claim 16 further comprising gassing a diluted brine containing sodium chloride or potassium chloride through the reactor.

18. The reactor according to claim 9 wherein the polymeric organic material is halogenated, and is provided with active carboxyl, sulfonic or amine groups.

19. The reactor according to claim 1 wherein the membrane (12) is shaped as a sheet or film made of a composite organic/inorganic material.
